(19) United States
(12) Patent Application Publication
(10) Pub. No.: US 2021/0192563 A1
(43) Pub. Date: Jun. 24, 2021

(54) WEBPAGE ADVERTISEMENT ANTI-BLOCKING METHOD, CONTENT DELIVERY NETWORK, AND CLIENT TERMINAL

(71) Applicant: WANGSU SCIENCE & TECHNOLOGY CO., LTD., Shanghai (CN)

(72) Inventors: Zhiwen ZHAO, Shanghai (CN); Tumu LIN, Shanghai (CN); Jian ZHOU, Shanghai (CN)

(21) Appl. No.: 16/079,784

(22) PCT Filed: Feb. 12, 2018
(86) PCT No.: PCT/CN2018/076410

§ 371 Date: Aug. 24, 2018

(30) Foreign Application Priority Data
Jan. 4, 2018 (CN) 201810007922.3

(51) Int. Cl. G06Q 30/02; H04L 29/06

(52) U.S. Cl. CPC G06Q 30/0244; H04L 65/608; H04L 65/4084; G06Q 30/0277

(57) ABSTRACT

A webpage advertisement anti-blocking method includes: receiving an access request for a target page issued by a client terminal, and in response to the access request, feeding back a response including a detection script to the client terminal, wherein the detection script, when running on the client terminal, detects whether there exists an advertisement blocking component on the client terminal and whether the client terminal supports a specified transmission protocol, and determines, based on a detection result on the client terminal, whether to transmit loading information of the target page to an advertisement request rewriting module, to allow the advertisement request rewriting module to rewrite an advertisement request included in the loading information as a rewritten request complying with the specified transmission protocol.

### FIELD OF THE DISCLOSURE

The present disclosure generally relates to the field of Internet technology and, more particularly, relates to a webpage advertisement anti-blocking method, a content delivery network, and a client terminal thereof.

### BACKGROUND

The advertisements on the webpages are ubiquitous, and are important sources of income for webpage administrators. Online advertisements may be in the form of banners, pop-ups, embedded pages, etc., and may be audio content, text, images, or visual content of other multimedia content. However, since most users do not want to see the advertisements on the webpages, advertisement blocking tools have thus been developed to block advertisements on the webpages.

In general, advertisement blocking tools come in many forms. For example, the advertisement blocking tools may be a software application, a browser component or extension, an add-on, a script, or a service that is used in conjunction with a web browsing application (such as Chrome, Internet Explorer, and Firefox), etc. The advertisement blocking tools usually work on the client terminals. The general method used by the advertisement blocking tools is to blacklist the communication addresses of the advertisement servers that the webpages need to access, so that the client terminals' accesses to these advertisement servers are blocked, resulting in webpages not being able to get the advertising contents. The advertisement blocking tools affect the advertisement revenue of the webpage administrators, and also prevent the marketing, promotion, and information dissemination of products and services of related businesses. Therefore, currently, there is a need to ensure that advertising contents can be presented on the users' devices in an expected manner.

At present, advertisement anti-blocking methods generally include encrypting or adding interfering elements to the communication addresses of the advertisement servers, so as to make the blacklist of the advertisement blocking tools unresponsive, or employing intermediate proxy servers to pass the advertisement requests. However, with the updating of the blacklist of the advertisement blocking tools, the communication addresses with the encryption or interfering elements or even the communication addresses of the intermediate proxy servers may also be added to the blacklist, which makes the existing advertisement anti-blocking methods ineffective. Therefore, there is a need for a more effective advertisement anti-blocking method.

### BRIEF SUMMARY OF THE DISCLOSURE

The purpose of the present disclosure is to provide a webpage advertisement anti-blocking method, a content delivery network, and a client terminal thereof, that may prevent advertisement requests from being blocked.

To achieve the above purpose, in one aspect, the present disclosure provides a webpage advertisement anti-blocking method, and the method may be applied to a content delivery network. The method includes: receiving an access request for a target page issued by a client terminal, and in response to the access request, feeding back a response including a detection script to the client terminal, where the detection script, when running on the client terminal, detects whether there exists an advertisement blocking component on the client terminal and whether the client terminal supports a specified transmission protocol, and determines, based on a detection result on the client terminal, whether to transmit loading information of the target page to an advertisement request rewriting module, to allow the advertisement request rewriting module to rewrite an advertisement request included in the loading information as a rewritten request complying with the specified transmission protocol.

To achieve the above purpose, in another aspect, the present disclosure further provides a content delivery network. The content delivery network comprises an edge node and an advertisement request rewriting module, where: the edge node is configured to receive an access request for a target page issued by a client terminal, and in response to the access request, feed back a response including a detection script to the client terminal, where the detection script, when running on the client terminal, detects whether there exists an advertisement blocking component on the client terminal and whether the client terminal supports a specified transmission protocol, and determines whether to transmit loading information of the target page to an advertisement request rewriting module based on a detection result on the client terminal; and the advertisement request rewriting module is configured to rewrite an advertisement request included in the loading information as a rewritten request complying with the specified transmission protocol, and provide the edge node with the loading information written with the included rewritten request.

To achieve the above purpose, in another aspect, the present disclosure further provides a webpage advertisement anti-blocking method, the method includes: issuing an access request for a target page to an edge node in a content delivery network, and receiving a response including a detection script fed back by the edge node; running the detection script to detect whether there exists an advertisement blocking component and whether a specified transmission protocol is supported, and to determine whether to transmit loading information of the target page to an advertisement request rewriting module based on a detection result, to allow the advertisement request rewriting module to rewrite an advertisement request included in the loading information as a rewritten request complying with the specified transmission protocol; when running the loading information, issuing the rewritten request to a request conversion server in the content delivery network to allow the request conversion server to restore the rewritten request to the advertisement request and obtain a corresponding advertisement resource from an advertisement server based on the restored advertisement request; and receiving the advertisement resource fed back by the request conversion server.

To achieve the above purpose, in another aspect, the present disclosure further provides a client terminal. The client terminal comprises a memory and a processor, where the memory stores computer programs that, when executed by the processor, implement the following steps: issuing an access request for a target page to an edge node in a content delivery network, and receiving a response including a detection script fed back by the edge node; running the detection script to detect whether there exists an advertisement blocking component and whether a specified transmission protocol is supported, and to determine whether to transmit loading information of the target page to an advertisement request rewriting module based on a detection result, to allow the advertisement request rewriting module to rewrite an advertisement request included in the loading information as a rewritten request complying with the specified transmission protocol; when running the loading information, issuing the rewritten request to a request conversion server in the content delivery network to allow the request conversion server to restore the rewritten request to the advertisement request and obtain a corresponding advertisement resource from an advertisement server based on the restored advertisement request; and receiving the advertisement resource fed back by the request conversion server.

As can be seen from the above, in the technical solutions provided by the present disclosure, when the client terminal issues an access request for a target page, the edge node in the content delivery network may determine whether the operator of the target page has applied for anti-blocking service. If the client terminal has applied for the service, a detection script may be fed back to the client terminal. The detection script may automatically run on the client terminal, and detect whether there exists an advertisement blocking component on the client terminal. If there exists an advertisement blocking component on the client terminal, the detection script may rewrite the advertisement request on the page to a request that complies with another transmission protocol. In this way, the rewritten request may not be blocked by the advertisement blocking component, so that the corresponding advertisement resource can be loaded smoothly. Specifically, after detecting the detection result corresponding to the client terminal, the client terminal may re-generate an access request for the target page, but with the detection result added into the access request. The access request with the added detection result is re-issued to the edge node. The edge node may proceed accordingly based on the detection result included in the access request. Specifically, if there exists an advertisement blocking component on the client terminal, the edge node may first obtain the loading information of the page from the source station server based on the access request. The loading information is then transmitted to the advertisement request rewriting module of the content delivery network. The advertisement request rewriting module may rewrite the advertisement request in the loading information as a rewritten request complying with a specified transmission protocol according to the specified transmission protocol supported by the client terminal, and write the rewritten request into the loading information. In this way, when the client terminal runs the loading information written with the included rewritten request, the rewritten request may be transmitted to the request conversion server in the content delivery network. Since the rewritten request is not in the blacklist of the advertisement blocking component, it can thus be normally issued by the client terminal. After receiving the rewritten request, the request conversion server may restore the rewritten request to the original advertisement request and obtain the corresponding advertisement resource from the advertisement server. After all, the obtained advertisement resource may be fed back to the client terminal, so that the advertisement on the page can be displayed on the client terminal as usual. In the above-described technical solutions, the specified transmission protocol differs from the protocol followed by the advertisement request. For example, the advertisement request follows the HTTP protocol, while the specified transmission protocol may be a WebRTC protocol or a WebSocket protocol. Since the blacklist in the advertisement blocking components usually only updates HTTP requests, it may not block a rewritten rewritten request. In addition, the request conversion server in the content delivery network usually does not display the communication address, and thus it is impossible to block the communication address of the request conversion server. In this way, the technical solutions provided by the present disclosure may more effectively prevent advertisement requests from being blocked, and thus the benefits of the webpage administrators and advertisement distributors can be ensured.

### BRIEF DESCRIPTION OF THE DRAWINGS

To make the technical solutions in the embodiments of the present disclosure clearer, a brief introduction of the accompanying drawings consistent with descriptions of the embodiments will be provided hereinafter. It is to be understood that the following described drawings are merely some embodiments of the present disclosure. Based on the accompanying drawings and without creative efforts, persons of ordinary skill in the art may derive other drawings.

FIG. 1 is a flowchart of a webpage advertisement anti-blocking method according to someone embodiments of the present disclosure;

FIG. 2 is a schematic diagram showing execution of a detection script according to some embodiments of the present disclosure;

FIG. 3 is a flowchart of rewriting an advertisement request according to some embodiments of the present disclosure;

FIG. 4 is a flowchart showing operation of a request conversion server according to some embodiments of the present disclosure;

FIG. 5 is an interactive diagram of various components in a content delivery network according to some embodiments of the present disclosure;

FIG. 6 is a structural schematic diagram of a client terminal according to some embodiments of the present disclosure; and

FIG. 7 is a structural schematic diagram of a computer terminal according to some embodiments of the present disclosure.

### DETAILED DESCRIPTION

To make the objectives, technical solutions, and advantages of the present disclosure clearer, specific embodiments of the present disclosure will be made in detail with reference to the accompanying drawings.

### Embodiment 1

The present disclosure provides a webpage advertisement anti-blocking method, which is applied to a content delivery network (CDN). The method may include:

receiving an access request for a target page issued by a client terminal, and in response to the access request, feeding back a response including a detection script to the client terminal, where the detection script, when running on the client terminal, detects whether there exists an advertisement blocking component on the client terminal and whether the client terminal supports a specified transmission protocol, and determines, based on a detection result on the client terminal, whether to transmit loading information of the target page to an advertisement request rewriting module, to allow the advertisement request rewriting module to rewrite an advertisement request included in the loading information as a rewritten request complying with the specified transmission protocol.

In the disclosed embodiment, when accessing a target page, a client terminal may issue an access request for the target page. The access request may be received by a nearby edge node in the CDN. After receiving the access request for the target page, the edge node may first determine whether the operator of the target page has applied for advertisement anti-blocking service. Specifically, target pages that currently have applied for the advertisement anti-blocking service may be recorded in the edge node in advance. For example, the edge node may record the IP addresses corresponding to the target pages that have applied for the advertisement anti-blocking service in an advertisement anti-blocking list. In this way, upon receiving the access request, the edge node may extract the IP address associated with the request from the access request, and determine whether the extracted IP address is in the list. If the extracted IP address is in the list, it indicates that the operator of the target page has applied for the advertisement anti-blocking service.

In the disclosed embodiment, when it is determined that the target page is in the advertisement anti-blocking list, the edge node may take measures for advertisement anti-blocking. Otherwise, the access request is processed in a normal way. Specifically, after it is determined that the target page is in the advertisement anti-blocking list, the edge node may feed back a response including a detection script to the client terminal. The detection script may be a piece of program code stored in advance in the edge node that can be executed. After the detection script is received by the client terminal, the client terminal may automatically run the detection script. When the detection script is running, it may detect whether there exists an advertisement blocking component on the client terminal. The specific detection method may include: at first, acquiring a target address in a blocking list of the advertisement blocking component. The target address may be any address in the blocking list. In order to share the addresses in the blocking list, different advertisement blocking components usually add addresses that need to be blocked into a shared library. In the present disclosure, any target address in the shared library may be obtained, and the page resource associated with the target address may be loaded. If the page resource can be loaded successfully, it indicates that no component for blocking the advertisement requests is installed on the client terminal. At this point, the running detection script may designate an indicator to indicate that there is no advertisement blocking component on the client terminal. If the page resource fails to be loaded, it indicates that there is a component for blocking the advertisement requests on the client terminal. At this point, the running detection script may designate an indicator to indicate that there exists an advertisement blocking component on the client terminal.

In the disclosed embodiment, when it is detected that there exists an advertisement blocking component on the client terminal, it may be further detected whether the client terminal supports a specified transmission protocol. The specified transmission protocol may be different from the transmission protocol used for the advertisement request. For example, currently, the advertisement requests generally use the HTTP protocol. In the disclosed embodiment, the specified transmission protocol may be a Web Real-Time Communication (WebRTC) protocol or a WebSocket protocol. Apparently, in real application scenarios, other protocols that are different from the HTTP protocol may also be applicable, which are not limited by the present disclosure. Since the WebRTC protocol has a wider range of applications than the WebSocket protocol, in the disclosed embodiment, it may be preferentially detected whether the client terminal supports a WebRTC protocol. If the client terminal does not support a WebRTC protocol, it may be further detected whether the client terminal supports a WebSocket protocol. In this way, after detecting whether the client terminal has an advertisement blocking component and whether the client terminal supports a specified transmission protocol, a corresponding detection result may be generated.

In the disclosed embodiment, after the detection result is obtained, if there exists an advertisement blocking component on the client terminal, the edge node cannot directly provide the loading information of the target page to the client terminal. Otherwise, the advertisement resource on the target page will be blocked by the advertisement blocking component. In view of this, the loading information of the target page may be transmitted to an advertisement request rewriting module. It should be noted that the advertisement request rewriting module may be located on the server side of the content delivery network, or on the client terminal side. Specifically, an advertisement anti-blocking script including an advertisement URL (Uniform Resource Locator) rewriting script may be embedded on the target page. The advertisement anti-blocking script first detects whether there exists an advertisement blocking component on the client terminal and detects whether the client terminal supports a specified transmission protocol. Based on the detection result, the loading information of the target page is collected. The collected loading information is transmitted to the advertisement URL rewriting script to be input into the URL rewriting logic. The advertisement URL rewriting script may serve as an execution script of the advertisement request rewriting module on the client terminal. The advertisement request rewriting module may rewrite the advertisement request included in the loading information as a rewritten request complying with the specified transmission protocol. Specifically, the advertisement request rewriting module may pre-run the loading information. When the loading information is executed, if an advertisement resource needs to be loaded on the page, an advertisement request for the advertisement resource will be issued. At this point, the advertisement request rewriting module may receive the advertisement request issued during the pre-running of the loading information. The advertisement requests usually have the HTTP protocol format. If the advertisement request is located in the blocking list of the advertisement blocking component, the request will be blocked by the advertisement blocking component. Therefore, when it is determined that the advertisement request is in a blocked state, the advertisement request rewriting module may generate a rewritten request complying with the specified transmission protocol corresponding to the advertisement request, and write the rewritten request into the loading information.

In the disclosed embodiment, after writing the rewritten request into the loading information, the advertisement request rewriting module may provide the loading information written with the included rewritten request to the edge node, to allow the edge node to feed back the loading information written with the included rewritten request to the client terminal.

In the disclosed embodiment, when the client terminal runs the loading information written with the included rewritten request, the rewritten request included therein may be issued. In the CDN, a server for processing the rewritten request complying with the specified transmission protocol may be configured in advance. Specifically, the server may be a request conversion server. The rewritten request issued by the client terminal may be received by the request conversion server. The request conversion server may restore the rewritten request to an advertisement request, obtain the corresponding advertisement resource from the advertisement server based on the restored advertisement request, and provide the obtained advertisement resource to the client terminal. In this way, the client terminal may obtain and display the advertisement resource as usual.

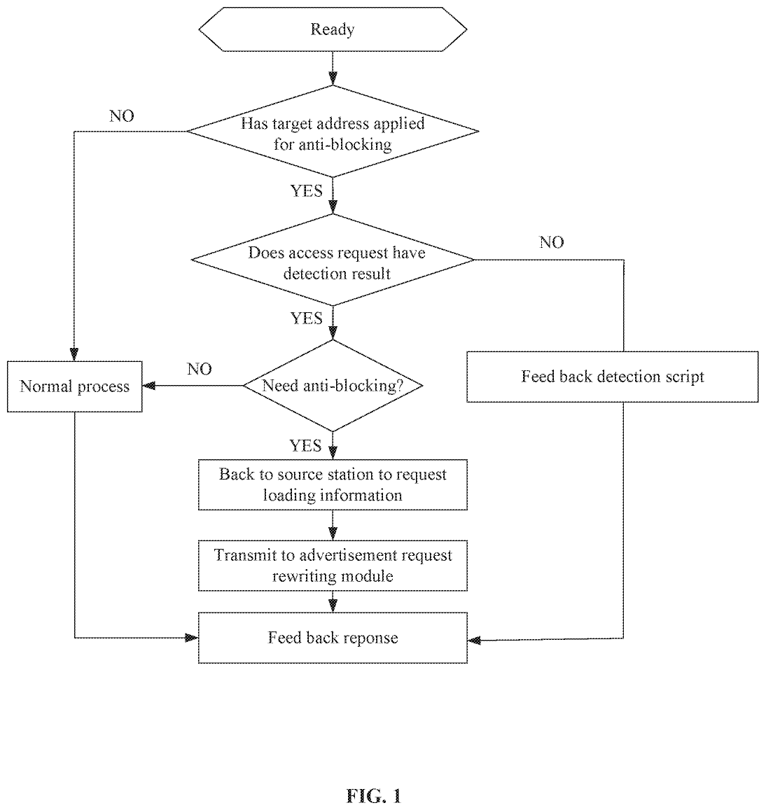

Specifically, referring to FIG. 1-FIG. 4, in some embodiments, the method includes the following steps.

S11: receiving a first access request for the target page issued by the client terminal and, in response to the first access request, feeding back the detection script to the client terminal, where the detection script, when running on the client terminal, detects whether exists the advertisement blocking component on the client terminal and whether the client terminal supports the specified transmission protocol, and generates a second access request for the target page, where the second access request includes the detection result on the client terminal.

Referring to FIG. 1, in the disclosed embodiment, when the client terminal accesses the target page, a first access request for the target page may be issued. The first access request may be received by a nearby edge node in the CDN. After receiving the first access request for the target page, the edge node may first determine whether the operator of the target page has applied for the advertisement anti-blocking service. Specifically, target pages that currently have applied for the advertisement anti-blocking service may be recorded in advance in the edge node. For example, the edge node may record the IP addresses corresponding to the target pages that have applied for the advertisement anti-blocking service in the advertisement anti-blocking list. In this case, upon receiving the first access request, the edge node may extract the IP address associated with the request from the first access request, and determine whether the extracted IP address is in the list. If the extracted IP address is in the list, it indicates that the operator of the target page has applied for the advertisement anti-blocking service.

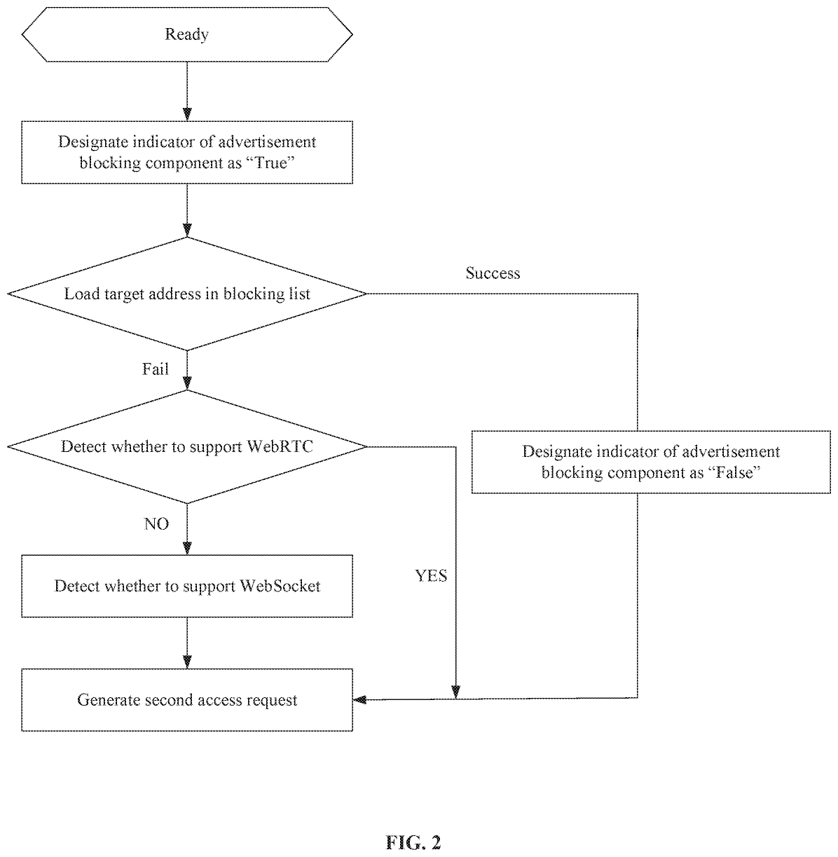

In the disclosed embodiment, the edge node may take measures for advertisement anti-blocking when it is determined that the target page is in the advertisement anti-blocking list. Otherwise, the first access request is processed in a normal way. Specifically, after it is determined that the target page is in the advertisement anti-blocking list, the edge node may feed back a detection script to the client terminal. The detection script may be a piece of program code stored in advance in the edge node that can be executed. After the detection script is received by the client terminal, the client terminal may automatically run the detection script. When the detection script is running, it may detect whether there exists an advertisement blocking component on the client terminal. The specific detection method may be: at first, obtaining a target address in a blocking list of the advertisement blocking component. The target address may be any address in the blocking list. In order to share the addresses in the blocking list, different advertisement blocking components usually add addresses that need to be blocked into a shared library. In the present disclosure, any target address may be obtained from the shared library. The page resource associated with the target address may then be loaded. If the page resource can be loaded successfully, it indicates that no component for blocking the advertisement requests is installed on the client terminal. At this point, the running detection script may designate an indicator to indicate that there is no advertisement blocking component on the client terminal. For example, “false” may be used as an indicator to indicate that there is no advertisement blocking component on the client terminal. If the page resource fails to be loaded, it indicates that there is a component for blocking the advertisement requests on the client terminal. At this point, the running detection script may designate an indicator to indicate that there exists an advertisement blocking component on the client terminal. For example, “true” may be used as an indicator to indicate that there exists an advertisement blocking component on the client terminal. Apparently, in actual application scenarios, as shown in the schematic diagram of FIG. 2, an indicator “true” may be designated in advance to indicate that there exists an advertisement blocking component on the client terminal. When it is detected later that there is no advertisement blocking component on the client terminal, the indicator “true” is changed to “false”.

In the disclosed embodiment, when it is detected that there exists an advertisement blocking component on the client terminal, it may be further detected whether the client terminal supports a specified transmission protocol. The specified transmission protocol may be different from the transmission protocol used for the advertisement request. For example, the present advertisement requests generally use the HTTP protocol. In the disclosed embodiment, the specified transmission protocol may be a WebRTC protocol or a WebSocket protocol. Of course, in actual application scenarios, other protocols that are different from the HTTP protocol may also be applicable, which are not limited by the present disclosure. Because the WebRTC protocol has a wider range of applications than the WebSocket protocol, in the disclosed embodiment, it may be preferentially detected whether the client terminal supports a WebRTC protocol. If the client terminal supports a WebRTC protocol, the running detection script may designate a numerical value that signifies the support of the WebRTC protocol. For example, “0” may be used to indicate that the client terminal supports a WebRTC protocol. If the client terminal does not support a WebRTC protocol, the running script may further detect whether the client terminal supports a WebSocket protocol. If the client terminal supports the WebSocket protocol, the running script may designate a numerical value to signify the support of the WebSocket protocol. For example, “1” may be used to indicate that the client terminal supports a WebSocket protocol. If neither protocol is supported, no corresponding numerical value is designated. In this way, after detecting whether the client terminal has an advertisement blocking component and whether it supports a specified transmission protocol, a corresponding detection result may be generated. In the detection result, the above-designated indicators and numerical values may be included. In actual applications, after it is detected that there is no advertisement blocking component on the client terminal, since the advertisement request will not be blocked, there is no necessity to further detect whether the client terminal supports a specified transmission protocol. In this case, the final detection result may be, for example, “false”, which indicates that there is no advertisement blocking component on the client terminal. The detection result may also be “true, 1”, which indicates that there exists an advertisement blocking component on the client terminal, and the client terminal supports the WebSocket protocol. In actual applications, the detection result may also be expressed in the form of a cookie. In the detection result, a field for indicating the meaning of an indicator or a numerical value may also be added. For example, “shield=true” may be used to indicate that there is an advertisement blocking component.

In the disclosed embodiment, after obtaining the detection result, the running detection script may generate a second access request for the target page. The difference between the second access request and the first access request is that: the second access request includes a detection result in addition to the access address of the target page. Here, the client terminal may re-issue the second access request including the detection result to the edge node.

In some embodiments, considering that an access request received by an edge node may include a detection result (for example, a second access request), or may not include a detection result (for example, a first access request), the edge node only needs to feed back the detection script for an access request that does not include a detection result. Accordingly, when it is determined that the target page is in the advertisement anti-blocking list, the edge node may further determine whether the first access request includes a detection result. If the first access request does not include a detection result, the edge node feeds back the detection script to the client terminal, to generate a detection result on the client terminal.

S13: receiving the second access request issued by the client terminal, and obtaining the loading information of the target page from a source station server based on the second access request.

S15: transmitting the loading information to the advertisement request rewriting module of the content delivery network, to allow the advertisement request rewriting module to rewrite the advertisement request included in the loading information as the rewritten request complying with the specified transmission protocol, and receiving the loading information written with the included rewritten request provided by the advertisement request rewriting module.

In the disclosed embodiment, after receiving the second access request issued by the client terminal, the edge node may extract the detection result included in the second access request, and take corresponding measures according to the detection result. Specifically, if the detection result indicates that there is no advertisement blocking component on the client terminal, the edge node may process the second access request in a normal way. If the detection result indicates that there exists an advertisement blocking component on the client terminal, the edge node may first obtain the loading information of the target page from the source station server corresponding to the target page. The loading information may be page code that can be executed by the client terminal. When the loading information is executed, the client terminal may obtain each display element on the target page and eventually display the information on the target page.

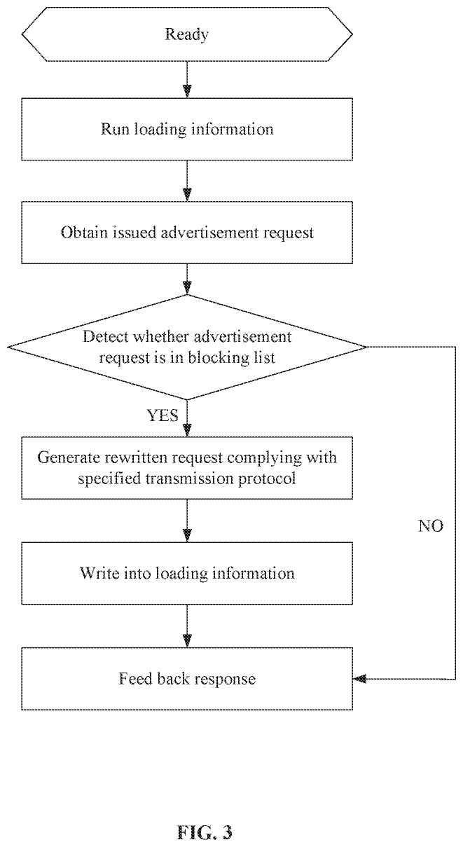

In the disclosed embodiment, because there exists an advertisement blocking component on the client terminal, the edge node may not directly provide the loading information to the client terminal. Otherwise, the advertisement resource on the target page will be blocked by the advertisement blocking component. In light of this, if an advertisement request rewriting module is located in the server of the content delivery network, the edge node may transmit the loading information to the advertisement request rewriting module of the content delivery network. The advertisement request rewriting module may rewrite the advertisement request included in the loading information as a rewritten request complying with the specified transmission protocol. Specifically, referring to FIG. 3, the advertisement request rewriting module may pre-run the loading information. When the loading information is executed, if an advertisement resource needs to be loaded on the page, an advertisement request for the advertisement resource will be issued. At this point, the advertisement request rewriting module may receive the advertisement request issued during the pre-running of the loading information. The advertisement requests usually have the HTTP protocol format. If the advertisement request is in the blocking list of the advertisement blocking component, the request will be blocked by the advertisement blocking component. Therefore, when it is determined that the advertisement request is in a blocked state, the advertisement request rewriting module may generate a rewritten request complying with the specified transmission protocol corresponding to the advertisement request, and write the rewritten request into the loading information. Here, the blocked state of the advertisement request may mean that the advertisement request is in the blocking list of the advertisement blocking component. When generating the rewritten request, the advertisement request rewriting module may rewrite the advertisement request according to the format requirement of the specified transmission protocol, thereby generating a rewritten request complying with the specified transmission protocol. The rewritten request may be written into the loading information of the target page. In this way, when the loading information is executed by the client terminal, the included advertisement request may be blocked by an advertisement blocking component, but the rewritten request can be issued as usual.

S17: feeding back the loading information written with the included rewritten request to the client terminal.

In the disclosed embodiment, after writing the rewritten request into the loading information, the advertisement request rewriting module may provide the loading information written with the included rewritten request to the edge node, to allow the edge node to feed back the loading information written with the included rewritten request to the client terminal.

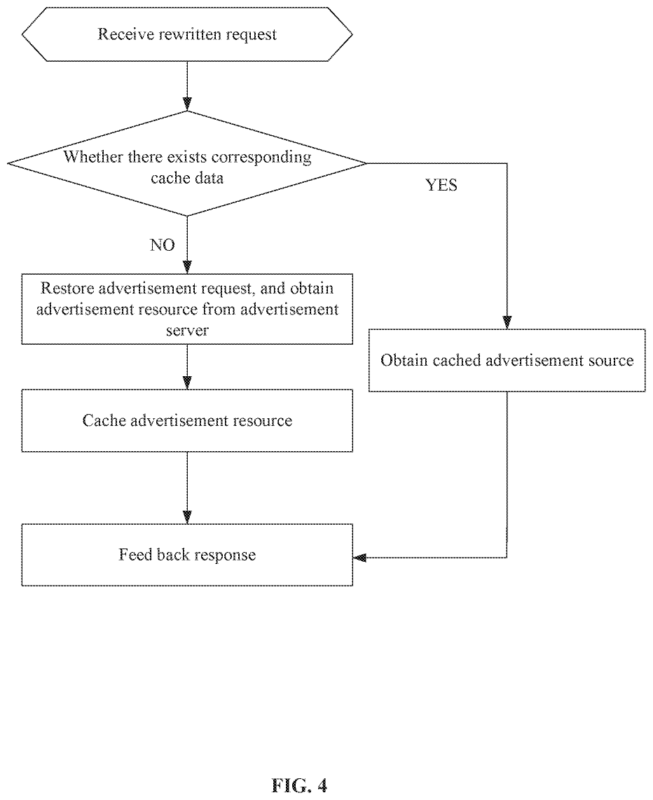

In the disclosed embodiment, when the client terminal runs the loading information written with the included rewritten request, the rewritten request included therein may be issued. In the CDN, a server for processing the rewritten request complying with the specified transmission protocol may be configured in advance. Specifically, referring to FIG. 4, the server may be a request conversion server. The rewritten request issued by the client terminal may be received by the request conversion server. The request conversion server may restore the rewritten request to an advertisement request, obtain the corresponding advertisement resource from the advertisement server based on the restored advertisement request, and provide the obtained advertisement resource to the client terminal. In this way, the client terminal may obtain and display the advertisement resource as usual.

In the disclosed embodiment, after the request conversion server obtains the corresponding advertisement resource, the request conversion server may cache the obtained advertisement resource. In this way, when the request conversion server receives a rewritten request associated with the advertisement resource again, the locally cached advertisement resource may be directly provided to the initiator of the request, thereby bypassing the process of obtaining the advertisement resource from the advertisement server, which reduces the client terminal response time. As can be seen, certain advertisement resources may be cached in the request conversion server in advance. In this way, when receiving a rewritten request issued by a client terminal, the request conversion server may determine whether there exists cache data corresponding to the rewritten request in the local. If there exists the cache data, the cache data may be provided to the client terminal. If there does not exist the cache data, the corresponding advertisement resource is then obtained from the advertisement server.

### Embodiment 2

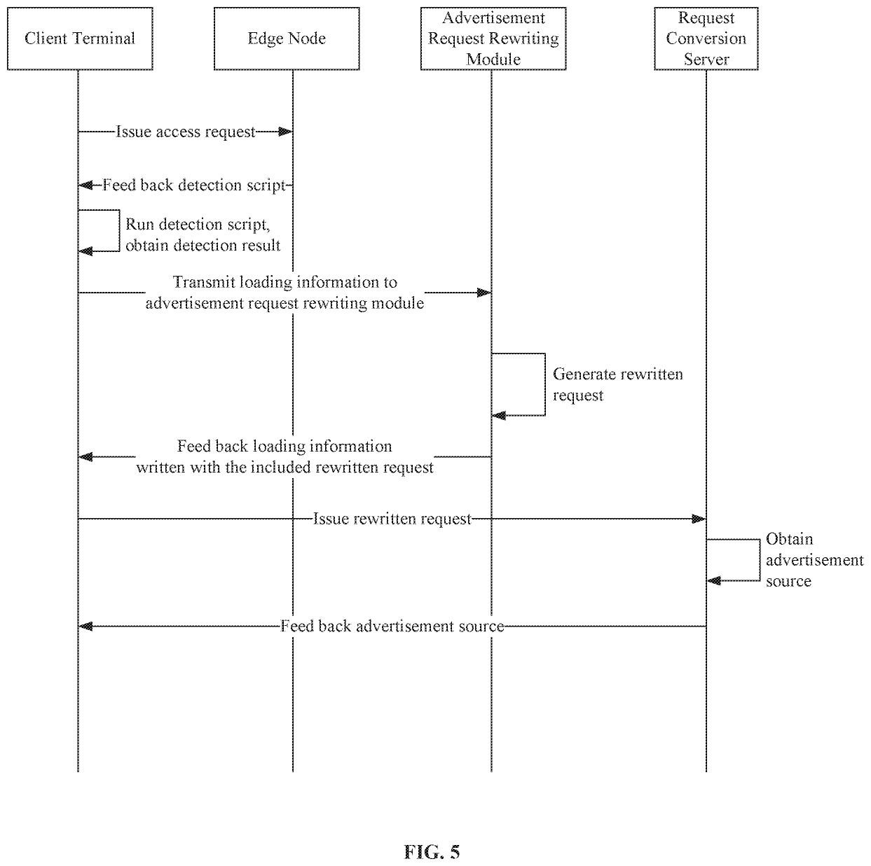

Referring to FIG. 5, the present disclosure further provides a content delivery network. The content delivery network comprises an edge node and an advertisement request rewriting module, where:

the edge node is configured to receive an access request for a target page issued by a client terminal, and in response to the access request, feed back a response including a detection script to the client terminal, where the detection script, when running on the client terminal, detects whether there exists an advertisement blocking component on the client terminal and whether the client terminal supports a specified transmission protocol, and determines whether to transmit loading information of the target page to an advertisement request rewriting module based on a detection result on the client terminal; and

the advertisement request rewriting module is configured to rewrite an advertisement request included in the loading information as a rewritten request complying with the specified transmission protocol, and provide the edge node with the loading information written with the included rewritten request.

In the disclosed embodiment, the content delivery network further includes a request conversion server, where the request conversion server is configured to receive the rewritten quest issued by the client terminal, restore the rewritten request to the advertisement request, obtain a corresponding advertisement resource from an advertisement server based on the restored advertisement request, and provide the obtained advertisement resource to the client terminal.

### Embodiment 3

The present disclosure further provides a webpage advertisement anti-blocking method, which may be applied to a client terminal. The method includes the following steps.

S21: issuing an access request for a target page to an edge node in a content delivery network, and receiving a response including a detection script fed back by the edge node.

S23: running the detection script to detect whether there exists an advertisement blocking component and whether a specified transmission protocol is supported, and to determine whether to transmit loading information of the target page to an advertisement request rewriting module based on a detection result, to allow the advertisement request rewriting module to rewrite an advertisement request included in the loading information as a rewritten request complying with the specified transmission protocol.

S25: when running the loading information, issuing the rewritten request to a request conversion server in the content delivery network to allow the request conversion server to restore the rewritten request to the advertisement request and obtain a corresponding advertisement resource from an advertisement server based on the restored advertisement request.

S27: receiving the advertisement resource fed back by the request conversion server.

In the disclosed embodiment, running the detection script includes:

obtaining in advance a target address in a blocking list of the advertisement blocking component, and loading a page resource associated with the target address; and

if the page resource is loaded successfully, designating an indicator to indicate that there does not exist an advertisement blocking component.

In the disclosed embodiment, the method further includes:

if the page resource fails to be loaded, designating an indicator to indicate that there exists an advertisement blocking component;

detecting whether the client terminal supports a WebRTC protocol, and if the client terminal supports a WebRTC protocol, designating a numerical value for signifying the support of the WebRTC protocol; and if the client terminal does not support a WebRTC protocol, detecting whether the client terminal supports a WebSocket protocol, and if the client terminal supports a WebSocket protocol, designating a numerical value for signifying the support of the WebSocket protocol; and

correspondingly, including the designated indicators and the designated numerical values in the detection result.

In the webpage advertisement anti-blocking method provided by the present embodiment, the specific implementation process of each step may refer to the description in Embodiment 1, which will not be described here.

### Embodiment 4

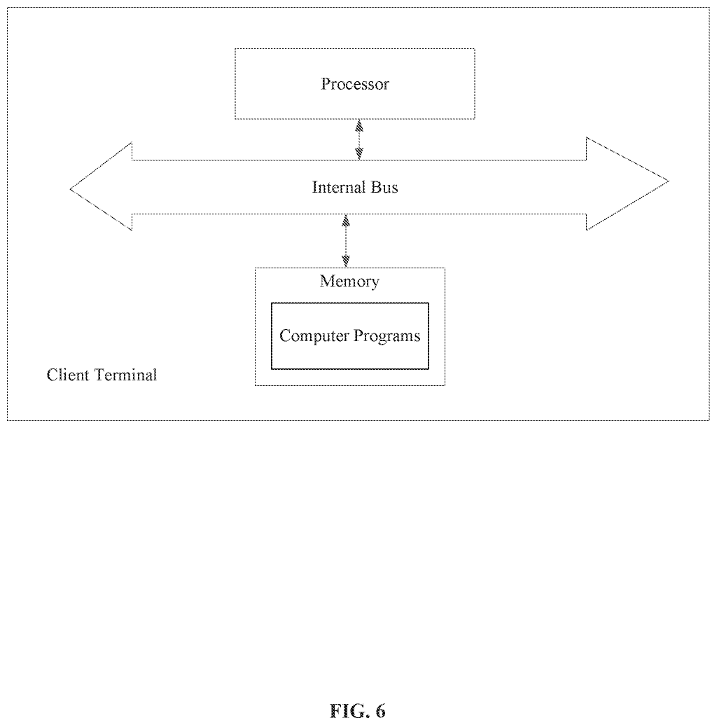

Referring to FIG. 6, the present disclosure further provides a client terminal. The client terminal comprises a memory and a processor, where the memory stores computer programs that, when executed by the processor, implement the following steps.

S21: issuing an access request for a target page to an edge node in a content delivery network, and receiving a response including a detection script fed back by the edge node.

S23: running the detection script to detect whether there exists an advertisement blocking component and whether a specified transmission protocol is supported, and to determine whether to transmit loading information of the target page to an advertisement request rewriting module based on a detection result, to allow the advertisement request rewriting module to rewrite an advertisement request included in the loading information as a rewritten request complying with the specified transmission protocol.

S25: when running the loading information, issuing the rewritten request to a request conversion server in the content delivery network to allow the request conversion server to restore the rewritten request to the advertisement request and obtain a corresponding advertisement resource from an advertisement server based on the restored advertisement request.

S27: receiving the advertisement resource fed back by the request conversion server.

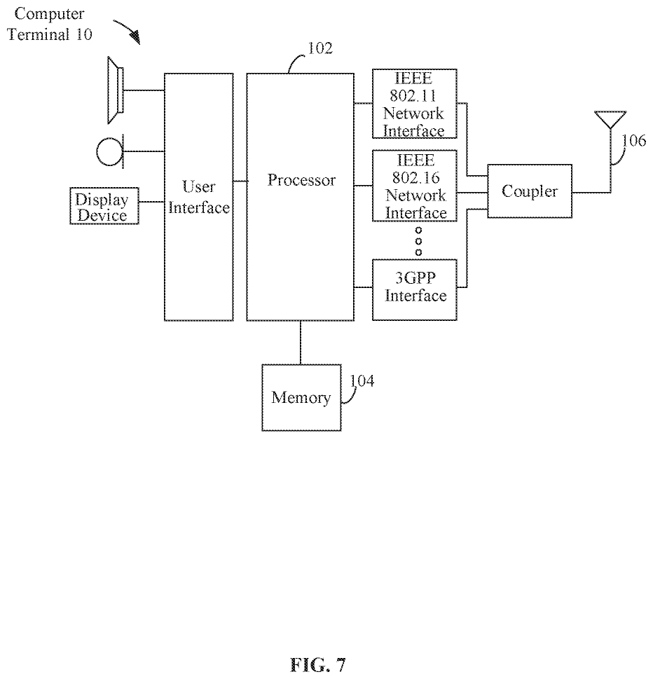

Referring to FIG. 7, in the present disclosure, the technical solutions in the foregoing embodiments may be applied to a computer terminal 10 shown in FIG. 7. The computer terminal 10 may include one or more (only one is shown in the figure) processors 102 (a processor 102 may include, but is not limited to, a processing device such as a microprocessor MCU or a programmable logic device FPGA), a memory 104 for storing data, and a transmission device 106 for communication purpose. Persons of ordinary skill in the art may understand that the structure shown in FIG. 7 is provided by way of illustration, but not by way of limitation of the structures of the above-described electronic devices. For example, the computer terminal 10 may also include more or fewer components than those shown in FIG. 7, or have a different configuration than that shown in FIG. 7.

The memory 104 may be used to store software programs and modules of application software. The processor 102 implements various functional applications and data processing by executing software programs and modules stored in the memory 104. The memory 104 may include a high-speed random access memory, and a non-volatile memory, such as one or more magnetic storage devices, flash memory, or other non-volatile solid-state memory. In some applications, the memory 104 may further include a memory remotely disposed with respect to the processor 102, which may be connected to the computer terminal 10 through a network. Examples of such network include, but are not limited to, the Internet, an intranet, a local area network, a mobile communication network, and combinations thereof.

The transmission device 106 is configured to receive or transmit data via the network. The aforementioned specific examples of the network may include a wireless network provided by the communication provider of the computer terminal 10. In one application, the transmission device 106 includes a network interface controller (NIC) that may be connected to other network devices through the base stations to allow it to communicate with the Internet. In one application, the transmission device 106 may be a Radio Frequency (RF) module that is configured to communicate with the Internet via a wireless approach.

The sequence numbers of the foregoing embodiments of the present disclosure are merely for descriptive purpose, and do not represent advantages and disadvantages of the embodiments.

Each embodiment in this specification is described in a progressive manner. The same or similar parts in each embodiment may be referred to each other. Each embodiment focuses on the difference from other embodiments. In particular, for the embodiments with respect to the content delivery network and the client terminal, reference may be made in detail to the foregoing embodiments for the methods.

As can be seen from the above, in the technical solutions provided by the present disclosure, when the client terminal issues an access request for a target page, the edge node in the content delivery network may determine whether the operator of the target page has applied for anti-blocking service. If the client terminal has applied for the service, a detection script may be fed back to the client terminal. The detection script may automatically run on the client terminal, and detect whether there exists an advertisement blocking component on the client terminal. It there exists an advertisement blocking component on the client terminal, the detection script may rewrite the advertisement request on the page to a request that complies with another transmission protocol. In this way, the rewritten request may be not blocked by the advertisement blocking component, so that the corresponding advertisement resource can be loaded smoothly. Specifically, after detecting the detection result corresponding to the client terminal, the client terminal may re-generate an access request for the target page, but with the detection result added into the access request. The access request with the added detection result is re-issued to the edge node. The edge node may proceed accordingly based on the detection result included in the request. Specifically, if there exists an advertisement blocking component on the client terminal, the edge node may first obtain the loading information of the page from the source station server based on the access request. The loading information is then transmitted to the advertisement request rewriting module of the content delivery network. The advertisement request rewriting module may rewrite the advertisement request in the loading information as a rewritten request complying with a specified transmission protocol according to the specified transmission protocol supported by the client terminal, and write the rewritten request into the loading information. In this way, when the client terminal runs the loading information written with the included rewritten request, the rewritten request may be transmitted to the request conversion server in the content delivery network. Since the rewritten request is not in the blacklist of the advertisement blocking component, it can thus be normally issued by the client terminal. After receiving the rewritten request, the request conversion server may restore the rewritten request to the original advertisement request and obtain the corresponding advertisement resource from the advertisement server. After all, the obtained advertisement resource may be fed back to the client terminal, so that the advertisement on the page can be displayed on the client terminal as usual. In the above-described technical solutions, the specified transmission protocol differs from the protocol followed by the advertisement request. For example, the advertisement request follows the HTTP protocol, while the specified transmission protocol may be a WebRTC protocol or a WebSocket protocol. Since the blacklist in the advertisement blocking components usually only updates HTTP requests, it may not block a rewritten rewritten request. In addition, the request conversion server in the content delivery network usually does not display the communication address, and thus it is impossible to block the communication address of the request conversion server. In this way, the technical solutions provided by the present disclosure may more effectively prevent advertisement requests from being blocked, and thus the benefits of the webpage administrators and advertisement distributors can be ensured.

Through the foregoing description of the embodiments, it is clear to those skilled in the art that the various embodiments may take the form of a software plus a necessary general hardware platform implementation, and entirely a hardware implementation. In light of this understanding, the technical solutions, or essentially the parts that contribute to the current technology, may be embodied by way of a software product. The computer software product may be stored in a computer-readable storage medium, such as a ROM/RAM, a magnetic disc, an optical disc, etc., and include a variety of programs that cause a computing device (which may be a personal computer, a server, or a network device, etc.) to implement each embodiment or methods described in certain parts of each embodiment.

Although the present disclosure has been described as above with reference to preferred embodiments, these embodiments are not constructed as limiting the present disclosure. Any modifications, equivalent replacements, and improvements made without departing from the spirit and principle of the present disclosure shall fall within the scope of the protection of the present disclosure.

1. A webpage advertisement anti-blocking method for a content delivery network, the method comprising:
receiving an access request for a target page issued by a client terminal, and in response to the access request, feeding back a response including a detection script to the client terminal, wherein the detection script, when running on the client terminal, detects whether there exists an advertisement blocking component on the client terminal and whether the client terminal supports a specified transmission protocol, and determines, based on a detection result on the client terminal, whether to transmit loading information of the target page to an advertisement request rewriting module, to allow the advertisement request rewriting module to rewrite an advertisement request included in the loading information as a rewritten request complying with the specified transmission protocol.

2. The method according to claim 1, wherein the loading information of the target page is obtained by:
receiving a first access request for the target page issued by the client terminal, and, in response to the first access request, feeding back the detection script to the client terminal, wherein the detection script, when running on the client terminal, detects whether exists an advertisement blocking component on the client terminal and whether the client terminal supports a specified transmission protocol, and generates a second access request for the target page, wherein the second access request includes the detection result on the client terminal; and
receiving the second access request issued by the client terminal, and obtaining the loading information of the target page from a source station server based on the second access request.

3. The method according to claim 1, wherein the advertisement request rewriting module is located in the content delivery network, and the method further includes:
transmitting the loading information to the advertisement request rewriting module of the content delivery network, to allow the advertisement request rewriting module to rewrite the advertisement request included in the loading information as the rewritten request complying with the specified transmission protocol, and receiving the loading information written with the included rewritten request provided by the advertisement request rewriting module; and
feeding back the loading information written with the included rewritten request to the client terminal.

4. The method according to claim 3, after feeding back the loading information written with the included rewritten request to the client terminal, the method further includes:
when the client terminal runs the loading information, issuing, by the client terminal, the rewritten request to a request conversion server in the content delivery network, wherein:
the request conversion server restores the rewritten request to the advertisement request, obtains a corresponding advertisement resource from an advertisement server based on the restored advertisement request, and provides the obtained advertisement resource to the client terminal.

5. The method according to claim 4, when the request conversion server receives the rewritten request issued by the client terminal, the method further includes:
determining, by the request conversion server, whether there exists cache data corresponding to the rewritten request;
if there exists the cache data corresponding to the rewritten request, providing, by the request conversion server, the cache data to the client terminal; and
if there does not exist the cache data there does not exist the cache data, obtaining, by the request conversion server, the corresponding advertisement resource from the advertisement server.

6. The method according to claim 5, after obtaining the advertisement resource from the corresponding advertisement server, the method further includes:
caching, by the request conversion server, the obtained advertisement resource, to allow the cached advertisement resource to be fed back to an initiator of the rewritten request when the rewritten request for the advertisement resource is received again.

7. The method according to claim 2, wherein obtaining the loading information of the target page from the source station server based on the second access request further includes:
extracting the detection result in the second access request, and obtaining the loading information of the target page from the source station server when the detection result indicates that there exists the advertisement blocking component on the client terminal.

8. The method according to claim 2, before feeding back the detection script to the client terminal, the method further includes:
determining whether the target page is in an advertisement anti-blocking list;
when it is detected that the target page is in the advertisement anti-blocking list, detecting whether the first access request includes a detection result; and
when it is detected that the first access request does not include a detection result, feeding back the detection script to the client terminal.

9. The method according to claim 1, when the detection script runs on the client terminal, the method further includes:
obtaining a target address in a blocking list of the advertisement blocking component, and loading a page resource associated with the target address; and
if the page resource is successfully loaded, designating an indicator to indicate that there does not exist an advertisement blocking component on the client terminal.

10. The method according to claim 9, further comprising:
if the page resource fails to be loaded, designating an indicator to indicate that there exists an advertisement blocking component on the client terminal;
detecting whether the client terminal supports a WebRTC protocol, and if the client terminal supports a WebRTC protocol, designating a numerical value for signifying the support of the WebRTC protocol, and if the client terminal does not support a WebRTC protocol, detecting whether the client terminal supports a WebSocket protocol, and if the client terminal supports a WebSocket protocol, designating a numerical value for signifying the support of the WebSocket protocol; and
including the designated indicators and the designated numerical values in the detection result.

11. The method according to claim 1, wherein rewriting, by the advertisement request rewriting module, the advertisement request included in the loading information into the rewritten request complying with the specified transmission protocol further includes:
pre-running the loading information, by the advertisement request rewriting module, and obtaining the advertisement request issued during the pre-running of the loading information; and
when it is determined that the advertisement request is in a blocked state, generating, by the advertisement request rewriting module, the rewritten request complying with the specified transmission protocol corresponding to the advertisement request, and writing the rewritten request into the loading information.

12. A content delivery network, comprising an edge node and an advertisement request rewriting module, wherein:
the edge node is configured to receive an access request for a target page issued by a client terminal, and in response to the access request, feed back a response including a detection script to the client terminal, wherein the detection script, when running on the client terminal, detects whether there exists an advertisement blocking component on the client terminal whether there exists an advertisement blocking component on the client terminal and whether the client terminal supports a specified transmission protocol, and determines whether to transmit loading information of the target page to an advertisement request rewriting module based on a detection result on the client terminal; and
the advertisement request rewriting module is configured to rewrite an advertisement request included in the loading information as a rewritten request complying with the specified transmission protocol, and provide the edge node with the loading information written with the included rewritten request.

13. The content delivery network according to claim 12, further comprising a request conversion server, wherein:
the request conversion server is configured to receive the rewritten quest issued by the client terminal, restore the rewritten request to the advertisement request, obtain a corresponding advertisement resource from an advertisement server based on the restored advertisement request, and provide the obtained advertisement resource to the client terminal.

14. A webpage advertisement anti-blocking method for a client terminal, comprising:
issuing an access request for a target page to an edge node in a content delivery network, and receiving a response including a detection script fed back by the edge node;
running the detection script to detect whether there exists an advertisement blocking component and whether a specified transmission protocol is supported, and to determine whether to transmit loading information of the target page to an advertisement request rewriting module based on a detection result, to allow the advertisement request rewriting module to rewrite an advertisement request included in the loading information as a rewritten request complying with the specified transmission protocol;
when running the loading information, issuing the rewritten request to a request conversion server in the content delivery network to allow the request conversion server to restore the rewritten request to the advertisement request and obtain a corresponding advertisement resource from an advertisement server based on the restored advertisement request; and
receiving the advertisement resource fed back by the request conversion server.

15. The method according to claim 14, wherein running the detection script includes:
obtaining in advance a target address in a blocking list of the advertisement blocking component, and loading a page resource associated with the target address; and
if the page resource is loaded successfully, designating an indicator to indicate that there does not exist an advertisement blocking component.

16. The method according to claim 15, further comprising:
if the page resource fails to be loaded, designating an indicator to indicate that there exists an advertisement blocking component;
detecting whether the client terminal supports a WebRTC protocol, and if the client terminal supports a WebRTC protocol, designating a numerical value for signifying the support of the WebRTC protocol, and if the client terminal does not support a WebRTC protocol, detecting whether the client terminal supports a WebSocket protocol, and if the client terminal supports a WebSocket protocol, designating a numerical value for signifying the support of the WebSocket protocol; and
including the designated indicators and the designated numerical values in the detection result.

17. (canceled)
